(19) United States
(12) Patent Application Publication
(10) Pub. No.: US 2010/0080197 A1
(43) Pub. Date: Apr. 1, 2010

(54) METHOD AND SYSTEM FOR GIGABIT WIRELESS TRANSMISSION

(75) Inventors: Kelly G. KANELLAKIS, Toronto (CA); Peiying ZHU, Kanata (CA); Wen TONG, Ottawa (CA)

Correspondence Address: CHRISTOPHER & WEISBERG, P.A., 200 EAST LAS OLAS BOULEVARD, SUITE 2040, FORT LAUDERDALE, FL, 33301, US

(73) Assignee: NORTEL NETWORKS LIMITED, Saint-Laurent (CA)

(21) Appl. No.: 12/239,949

(22) Filed: Sep. 29, 2008

(51) Int. Cl. H04W 84/02; H04W 4/02; H04W 4/00

(52) U.S. Cl. 370/338; 455/456.1; 455/426.1

(57) ABSTRACT

A method and system for wireless communication with a mobile device. A first wireless communication network, such as a WiMax or cellular-based network, has a first maximum wireless speed. A second wireless communication network, such as a near-photonic speed gigabit link (“GiLink”) network, has a second maximum wireless speed. The second wireless maximum speed is less than the first maximum wireless speed. The second wireless communication network provides control plane services for wireless communication between the mobile device and the first wireless communication network.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a system and method for gigabit wireless communication and in particular to a method and system for determining the link connectivity for a gigabit wireless communication enabled mobile device, thereby facilitating high speed gigabit wireless communication with the mobile device.

### BACKGROUND OF THE INVENTION

As deployment and affordability increase for computing devices and computer networks, the services available on these networks also increase. The result is a demand for increased bandwidth and throughput. For example, while the transmission of simple text and graphics was the norm but a few years ago, streaming multimedia and huge multi-megabyte file transfers are the new norm. This necessitates ever-increasing network communication speeds. While hard-wired networks can support such demands through the deployment of hard-wired GBit/sec. (“GB”) Ethernet, fiber-optic and other high speed OSI Layer 1 communications, wireless networks currently can not readily and inexpensively support these communications. The result is that wide-spread deployment of wireless high speed broadband networks at 1 GB and above (“GiLink”) has not occurred.

Gigabit wireless transmission demands an excessive amount of scarce spectrum resource. Typically, the licensed spectrum results in excessive network cost. This lack of ultra-high wireless communication deployment is clearly evident in wireless local area networking (“LAN”). Such is the case due to the limited and expensive government licensing fees associated with the acquisition of portions of the radio frequency (“RF”) spectrum and the short communication range for unlicensed portions of the RF spectrum at higher carrier frequencies. For example, while the 60 GHz and 1 THz portions of the RF spectrum are not licensed, these frequencies are only suitable to support GiLink data rates for very short distances, e.g., meters or ten of meters

In addition, wireless communication at 60 GHz and THz requires line-of-sight (LOS) conditions. This introduces additional disadvantages to support the mobility service. Therefore, there is a constant need to identify the LOS connectivity for mobile device with the access points or other peer mobile device to establish a gigabit wireless communication link.

It is therefore desirable to have a method and system for providing wireless GiLink LANs which do not suffer from the above-referenced deficiencies. In particular, it is desirable to have method and system for providing cost effective wireless GiLink LANs which allow for the movement of GiLink-based mobile devices within the LAN and/or can readily locate the mobile device so that only the GiLink access point that needs to communicate with the wireless device is activated for such wireless high speed communication.

### SUMMARY OF THE INVENTION

The present invention advantageously provides a cost-effective method and system for wireless broadband, e.g., GiLink, local area network communications. To do so, an exemplary embodiment overlays a lower speed and long-range wireless, e.g., Wide Area Network (“WAN”), cellular or WiFi network on a GiLink-based wireless LAN. Such long-range wireless networks provided non line-of-sight (“NLOS”) wireless network connectivity. The mobile device supports both the lower speed, long-range network for NLOS communication, and the higher speed and short-range GiLink modes of communication such the long-range network can be used to determine or assist the GiLink connectivity of the mobile device to the access point or the peer mobile device within the LAN. It is contemplated that other methods for determining the connectivity for the mobile device within the GiLink LAN can be used.

In accordance with one aspect, the present invention provides a method for wireless communication with a mobile device using a first wireless communication network having a first maximum wireless speed and having a plurality of access points for communication with the mobile device, and a second wireless communication network having a second maximum wireless speed in which the second wireless maximum speed is less than the first maximum wireless speed. The second wireless communication network is used to assist determination of connectivity for the mobile device on the first wireless communication network. At least one of the plurality of access points on the first wireless communication network is activated to engage in wireless communication with the mobile device based on the determined connectivity for the mobile device.

In accordance with another aspect, the present invention provides a system for wireless communication with a mobile device. The system has a first wireless communication network and second wireless communication network. The first wireless communication network has a first maximum wireless speed and has a plurality of access points for communication with the mobile device. The second wireless communication network has a second maximum wireless speed in which the second wireless maximum speed is less than the first maximum wireless speed. The second wireless communication network is used to determine a location of the mobile device. At least one of the plurality of access points on the first wireless communication network are activated to engage in wireless communication with the mobile device based on the determined location of the mobile device.

In accordance with yet another aspect, the present invention provides a system for wireless communication with a mobile device. A first wireless communication network has a first maximum wireless speed. A second wireless communication network has a second maximum wireless speed. The second wireless maximum speed is less than the first maximum wireless speed. The second wireless communication network provides control plane services for wireless communication between the mobile device and the first wireless communication network.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an exemplary system constructed in accordance with the principles of the present invention;

FIG. 2 is a diagram of the system of FIG. 1, showing a dual mode wireless device in connection with the low speed and GiLink (high speed) wireless networks;

FIG. 3 is a diagram of the system of FIG. 1, showing a dual mode wireless access point in connection with the low speed and GiLink (high speed) wireless networks;

FIG. 4 is a diagram of an exemplary GiLink (high speed) backbone network constructed in accordance with the principles of the present invention; and

FIG. 5 is a diagram of an exemplary node and wireless access point architecture constructed in accordance with the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for facilitating high speed wireless communications at photonic or near-photonic spectrum. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Referring now to the drawing figures in which like reference designators refer to like elements, there is shown in FIG. 1, a system constructed in accordance with the principles of the present invention and designated generally as “10”. System 10 includes a high speed network, such as a GiLink wireless network 12, and a low speed wireless network 14 in communication with a mobile device 16. Mobile device 16 can be any computing device arranged for wireless transmission with GiLink wireless network 12 and low speed wireless network 14 such as a laptop computer, personal digital assistant (“PDA”), cell phone, etc. These devices are listed purely for the purposes of providing suitable examples, and should not be considered in any way as limiting the scope of the present invention.

Although not shown, mobile device 16 includes a central processing unit, volatile and non-volatile storage memory user displays and input/output devices and programmatic software arranged to allow mobile device 16 to communicate with GiLink wireless network 12 and low speed wireless network 14

GiLink wireless network 12 is arranged to provide an extremely high maximum data rate, e.g., 1 Gbit per second and faster, for wireless communication with mobile device 16. In other words, it is presumed that GiLink wireless link 12 can communicate at photonic or near-photonic wireless communication speeds.

Low speed wireless network 14 operates such that its maximum wireless speed is less than the maximum wireless communication speed of GiLink wireless network 12 and in one embodiment, the coverage range for GiLink wireless network 12 is smaller than that of low speed wireless network 14.

In accordance with the present invention, low speed wireless network 14 provides control plane services for wireless communication between mobile device 16 and GiLink wireless network 12. For example, low speed wireless network 14 is arranged to carry low-rate control signaling to aid tracking the location/movement of mobile device 16, path/route discovery for communication within GiLink wireless network 12, fast handover between access points for GiLink wireless network 12, synchronization of communications between mobile device 16 and GiLink wireless network 12, network topology management and to facilitate peer-to-peer communications between wireless access points within GiLink wireless network 12 (discussed below). In accordance with one embodiment, GiLink wireless network 12 can provide wireless communications using currently unlicensed RF spectrum such as those in the 60 GHz, Tera Hertz, and light frequencies.

Of note, although FIG. 1 shows low speed wireless network 14 coupled to GiLink wireless network 12, such connection is optional. It is contemplated that low speed wireless network 14 can provide control plane information to GiLink wireless network 12 via mobile device 16. It is also contemplated that the low speed wireless network 14 can be used as a back-up channel complementary network and/or to augment communication between mobile device 16 and the end destination device and/or can be used to support low speed wireless communications while GiLink wireless network 12 is used for very large data transfers and/or other bandwidth intensive applications.

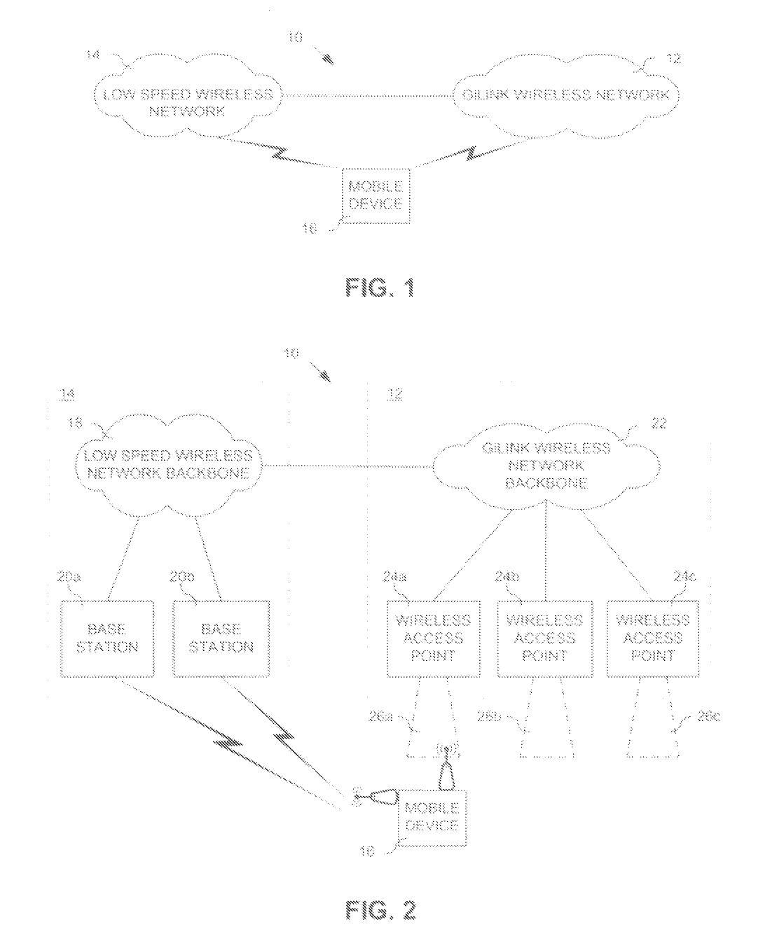

FIG. 2 shows an embodiment of the system shown in FIG. 1 in which a dual mode mobile device 16 is in communication with low speed wireless network 14 and GiLink wireless network 12. As is shown in FIG. 2, low speed wireless network 14 includes low speed wireless network backbone 18 in communication with base station 20a and base station 20b (referred to collectively herein as base station 20). Low speed wireless network 14 can be a cellular network, such as a 1xEV-DO or CDMA network or WiMAX network, or a WLAN, e.g., WiFi network, or any other suitable wireless wide area or local area network. The actual technology for implementing wireless wide area and low speed local networks is beyond the scope of the present invention and is not described herein.

In accordance with one embodiment, GiLink wireless network 12 includes GiLink wireless network backbone 22 (described below in more detail), in communication with one or more wireless access points 24a, 24b and 24c (referred to collectively herein as wireless access point 24). Each wireless access point 24 has a corresponding communication zone 26a, 26b and 26c (referred to collectively herein as communication zone 26). Communication zone 26 is the physical zone within which mobile device 16 can communicate with the corresponding wireless access point 24. Such is the case due to the directional and limited distance nature of wireless communication with GiLink wireless network 12 in spectrum bands such as the 60 GHz and Tera Hertz bands. Of note, although FIG. 2 shows two base stations 20 and three wireless access points 24, the present invention is not limited to such. The quantities of base stations 20 and wireless access points 24 shown in FIG. 2 are provided merely for the ease of explanation. It is understood that a low speed wireless network 14 implemented in accordance with the principles of the present invention may have many base stations 20 and that a GiLink wireless network 12 implemented in accordance with the principles of the present invention may have many wireless access points 24.

By way of example, and as explained below in more detail, in accordance with one embodiment, low speed wireless network 14 is used to determine the connectivity of mobile device 16 so that connectivity can be provided for the GiLink wireless network 12 for the activation of corresponding GiLink wireless network 12 wireless access points 24. In accordance with the present invention, such connectivity can include determining the location of mobile device 16, determining locations for line-of-sight communication between mobile device 16 and an access point 24, or between mobile device 16 and another peer mobile device 16, determining a line-of-sight range between mobile device 16 and an access point 24, or between mobile device 16 and another peer mobile device 16 and determining a line-of-sight link speed between mobile device 16 and an access point 24 or between mobile device 16 and another peer mobile device 16.

As shown in FIG. 2, mobile device 16 is arranged to communicate with GiLink wireless network 12 and with low speed wireless network 14. In accordance with this arrangement, low speed wireless network 14 is essentially “overlayed” onto GiLink wireless network 12 such that mobile device 16 is a dual mode device that is able to communicate with low speed wireless network 14 and GiLink wireless network 12. In accordance with this embodiment, low speed wireless network 14 is used to provide the control plane functions where control plane data is then passed from low speed wireless network 14 to GiLink wireless network 12 via mobile device 16 or via a direct communication link coupling the two networks. It is contemplated that such a direct coupling can facilitate communication via a known protocol such as transmission control protocol/internet protocol (“TCP/IP”).

As one example of a control plane service, low speed wireless network 14 can be used to determine the location of mobile device 16. The location information can be passed to GiLink wireless network 12. GiLink wireless network 12 can then activate the wireless access point 24 corresponding to the location of mobile device 16 so that mobile device 16 can engage in wireless communication using GiLink wireless network 12 based on this determined location. Of note, as used herein the term “activate” is not intended to imply solely that the wireless access point 24 is changed from a no or low power state to a high power state for engaging in communication. Rather, the term “activate” is used in a broader scope to mean taking any steps for communicating with mobile device 16. For example, “activate” can mean transmitting those data packets needed to establish a communication session with mobile device 16.

For example, FIG. 2 shows mobile device 16 located within communication zone 26a. This location can be determined by low speed wireless network 14 based on a known position locating technique such as triangulation where there are multiple communicating elements, e.g., base stations 20, by using a control signal or beacon and homing in on that signal strength or other information embedded in the signal transmitted by mobile device 16 or by using global positioning system (“GPS”) information from mobile device 16 and then activating the wireless access point 24 believed to be supporting that location. Once the position of mobile device 16 is determined, the corresponding wireless access point 24 is activated. It is noted that the activation of wireless access point 24 need not result in mutually exclusive communication using only GiLink wireless network 12. It is contemplated that mobile device 16 can communicate with both GiLink wireless network 12 and low speed wireless network 14 simultaneously.

In accordance with one embodiment, wireless access points 24 can be mounted in or on a ceiling such that communication zone 26 is established in a downward pattern. It is also contemplated that the antenna within wireless access point 24 can be aimed, whether physically or through some other mechanism such as a phased array, to direct the antenna and resultant communication zone 26 toward the mobile device 16 based on the determined location of the mobile device. For example, if mobile device 16 is not positioned directly within communication zone 26 when the corresponding wireless access point 24 antenna is in a default position, the location of mobile device 16 can be used to direct the antenna, and resultant communication zone 26 toward mobile device 16. In this manner, “dead zones” within a location can be avoided while also avoiding the need to include wireless access points 24 with overlapping communication zone coverage throughout an entire location. Similarly, by activating only a wireless access point 24 whose corresponding communication zone 26 can support mobile device 16, power and spectral bandwidth use can be minimized.

As another control plane service example, by determining the location of mobile device 16, low speed network 14 can support the movement and handoff from one wireless access point 24 to another wireless access point 24. For example, by knowing the location of mobile device 16 and by tracking its movement, mobile device 16 can provide GiLink wireless network backbone 22 with information, either collected from low speed wireless network 14 or operating in dual mode to forward the information from low speed wireless network 14 to the GiLink wireless network backbone 22 to allow the handoff of a communication session from one wireless access point 24 to another.

It is contemplated that communication between mobile device 16 and wireless access point 24 can use a frame structure such as a time domain wireless communication frame structure based on orthogonal frequency-division multiplexing (“OFDM”) TDD frame structures. Such an arrangement can be used to assist with the handoff of wireless communications from one wireless access point 24 to another wireless access point 24.

Although FIG. 2 shows a single mobile device 16, it is contemplated that system 10 can include multiple mobile devices 16. For example, the embodiment shown in FIG. 2 can support peer-to-peer communication between multiple mobile devices 16. As explained below in more detail, wireless access points corresponding to the mobile device 16 and another mobile device (not shown) can be established via two wireless access points 24 because GiLink wireless backbone 22 will have information from low speed wireless network 24 as to the location of each of the mobile devices 16.

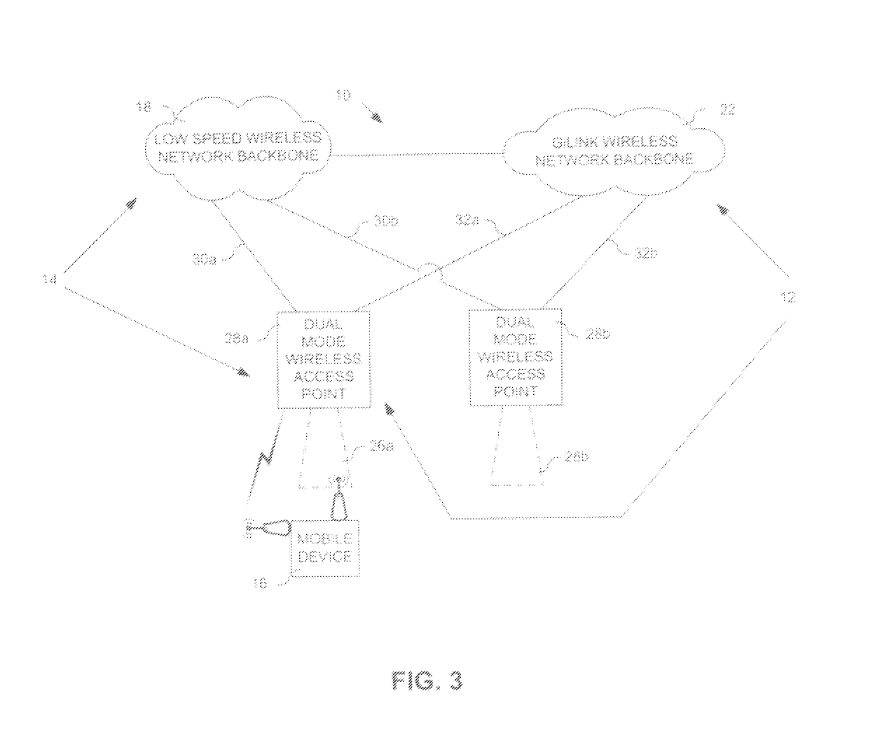

FIG. 3 shows another embodiment of system 10 constructed in accordance with the principles of the present invention. In FIG. 3, the wireless access point is arranged to operate in a dual mode such that the dual-mode wireless access point can communicate with both the low speed wireless network backbone 18 and the GiLink wireless network backbone 22. FIG. 3 shows dual-mode wireless access points 28a and 28b (referred to collectively herein as dual-mode wireless access point 28) coupled to low speed wireless network backbone 18 by links 30a and 30b, respectively, and to GiLink wireless network backbone 22 by links 32a and 32b, respectively. Links 30a and 30b are referred to collectively herein as link 30, and links 32a and 32b are referred to collectively herein as link 32.

In accordance with this embodiment, dual-mode wireless access points 28 provide both low speed wireless network backbone 18 and GiLink wireless network backbone 22 connectivity. As such, dual-mode access points 28 contain the programmatic software and hardware to allow communication with low speed wireless network 14 and GiLink wireless network 12 in wired or wireless fashion, as well as with the low speed and GiLink capabilities of mobile device 16. In accordance with one embodiment, dual-mode wireless access point 28 includes antennas and transceivers to support both the low speed and the GiLink wireless communications with mobile device 16.

In accordance with this embodiment, dual-mode wireless access point 28 can transmit low rate control information to low speed wireless network backbone 18 and receive information there from. Such control information can include the location tracking information of mobile device 16. Once determined, dual-mode wireless access point 28 can communicate with GiLink wireless network backbone 22 to facilitate GiLink (high speed) wireless communications.

The control plane services discussed above with respect to the embodiment of FIG. 2 are equally applicable with the embodiment shown in FIG. 3. It is also noted that the present invention is not limited solely to the embodiments shown in FIG. 2 and FIG. 3. For example, it is contemplated that a hybrid arrangement of the embodiments shown in FIG. 2 and FIG. 3 can be implemented. For example, mobile device 16 can itself be a dual-mode device and communicate with single-mode wireless access points that may be in the low speed wireless network 14. As such, an implementation of system 10 is not relegated to all dual-mode wireless access points 28 or none. A system 10 having a hybrid of wireless access points 28 and 24 (FIG. 2) can be implemented.

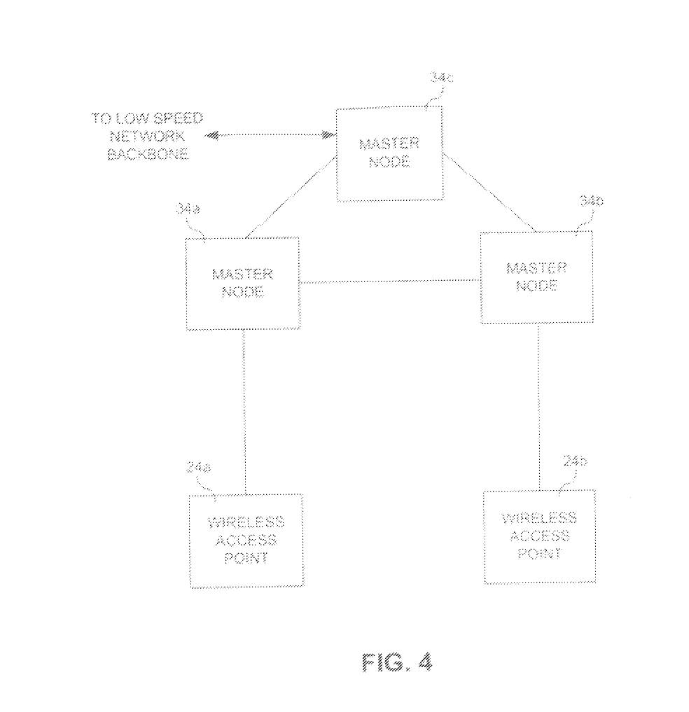

An exemplary GiLink wireless network backbone 22 is described with reference to FIG. 4. FIG. 4 shows wireless access points 24a and 24b in communication with master nodes 34a and 34b, respectively. Master nodes 34a, 34b and 34c are referred to collectively herein as master nodes 34. Although three master nodes 34 are shown in FIG. 4, the quantity and connectivity among master nodes 34 is shown solely for ease of explanation, it being understood that more or fewer master nodes 34 than is shown in FIG. 4 can be provided. Also, although the connectivity among master nodes 34 shown in FIG. 4 is a mesh topology, the invention is not limited to such. Any suitable connectivity arrangement can be implemented, such as a mesh, partial mesh, tree or hub and spoke topology can be implemented. Also, although FIG. 4 shows wireless access points 24 corresponding to those used in FIG. 2, it is contemplated that dual-mode wireless access points 28 can be implemented instead of or in conjunction with wireless access points 24.

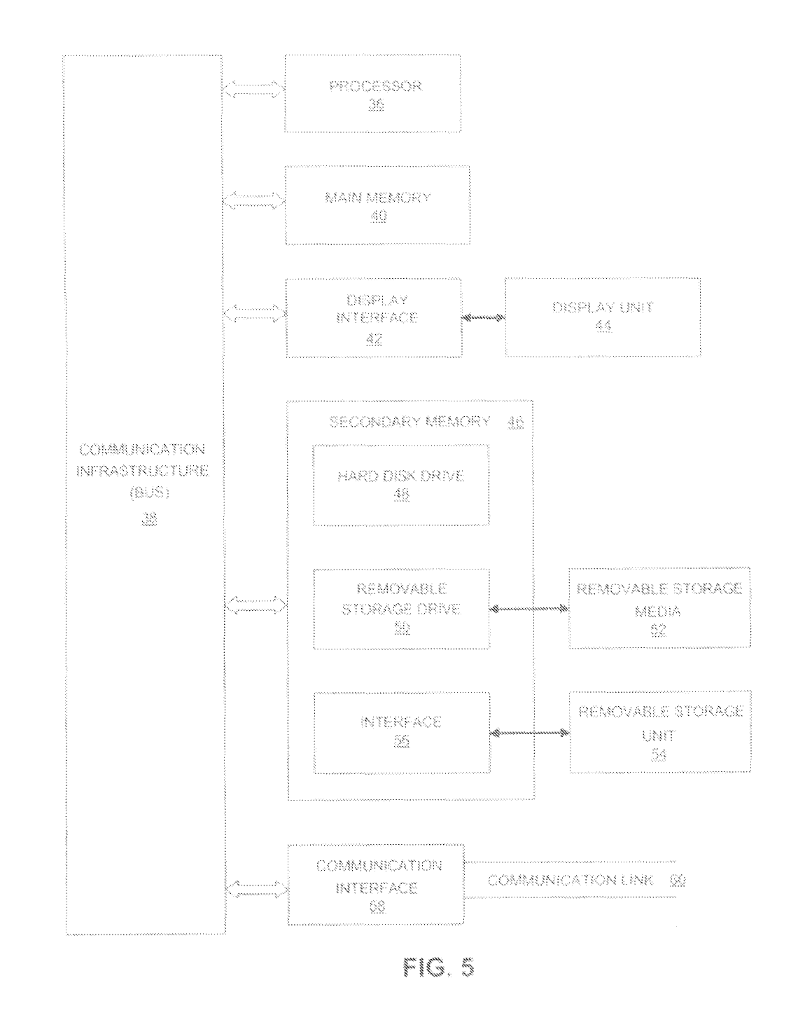

Master nodes 34 are arranged to facilitate communication with wireless access points 24. Also, although not shown, it is contemplated that one or more master nodes 34 can be used to connect to other networks, such as the internet In accordance with the present invention, master nodes 34 include the hardware and programmatic software for carrying out the functions discussed and described herein. The exemplary detailed architecture for master node 34 is discussed below with reference to FIG. 5.

In accordance with the present invention, a master node 34 can be physically separated from or incorporated with wireless access point 24 (or dual-mode wireless access point 28). Node 34 may contain a large cache memory to facilitate network topology management, synchronization, fast handover and route/path discovery to facilitate communication with mobile device 16 using GiLink wireless network 12. The communication between wireless access point 24 and master node 34 can be used to update information on the master node neighbor list, which itself may include some system information such as available and maximum bandwidth.

Although the data rate of GiLink wireless network 12 is greater than that of low speed wireless network 14 for both the wireless communication link with mobile device 16 and among master nodes 34, it is contemplated that GiLink wireless network 12 can be implemented using a wireless (“WLAN”) or wireless personal area network (“WPAN”) protocol. For example, although the communication speeds and OSI Layer 1 protocols would differ, by implementing low speed wireless network 14 and GiLink wireless network 12 using the same higher level protocol, e.g., a WiFi WLAN protocol, control plane service communication between low speed wireless network 14 and GiLink wireless network 12 can be simplified. Such protocols themselves are known in the art and are beyond the scope of the present invention.

Referring to FIG. 5, devices such as wireless access points 24 and 28, base stations 20 and master nodes 34 in an exemplary system 10 include one or more processors, such as processor 36. The processor 36 is connected to a communication infrastructure 38, e.g., a communications bus, cross-bar interconnect, network, etc. Various software embodiments are described in terms of this exemplary computer system. After reading this description, it will become apparent to a person of ordinary skill in the relevant art(s) how to implement the invention using other computer systems and/or computer architectures. It is also understood that the capacities and quantities of the components of the architecture described below may vary depending on the device, e.g., wireless access point 24 vs. master node 34, the quantity of mobile devices 16 to be supported, and well as the intended interaction with the device. For example, access to wireless access point for configuration and management may be designed to occur remotely by web browser. In such case, the inclusion of a display interface and display unit may not be required.

Wireless access points 24 and 28, base stations 20 and master nodes 34 can optionally include or share a display interface 42 that forwards graphics, text, and other data from the communication infrastructure 38 (or from a frame buffer not shown) for display on the display unit 44. The computer system of wireless access points 24 and 28, base stations 20 and master nodes 34 also includes a main memory 40, preferably random access memory (“RAM”), and may also include a secondary memory 46. The secondary memory 46 may include, for example, a hard disk drive 48 and/or a removable storage drive 50, representing a floppy disk drive, a magnetic tape drive, an optical disk drive, etc. The removable storage drive 50 reads from and/or writes to a removable storage media 52 in a manner well known to those having ordinary skill in the art. Removable storage media 52, represents, for example, a floppy disk, magnetic tape, optical disk, etc. which is read by and written to by removable storage drive 50. As will be appreciated, the removable storage media 52 includes a computer usable storage medium having stored therein computer software and/or data.

In alternative embodiments, the secondary memory 46 may include other similar means for allowing computer programs or other instructions to be loaded into the computer system and for storing data. Such means may include, for example, a removable storage unit 54 and an interface 56. Examples of such may include a program cartridge and cartridge interface (such as that found in video game devices), flash memory, a removable memory chip (such as an EPROM, EEPROM or PROM) and associated socket, and other removable storage units 54 and interfaces 56 which allow software and data to be transferred from the removable storage unit 54 to the wireless access points 24 and 28, base stations 20 and master nodes 34.

Wireless access points 24 and 28, base stations 20 and master nodes 34 may also include a communications interface 58. Communications interface 58 allows software and data to be transferred between the wireless access points 24 and 28, base stations 20 and master nodes 34 and external devices. Examples of communications interface 58 may include a modem, a network interface (such as an Ethernet card), a communications port, a PCMCIA slot and card, wireless transceiver/antenna, etc. Software and data transferred via communications interface/module 58 are in the form of signals which may be, for example, electronic, electromagnetic, optical, or other signals capable of being received by communications interface 58. These signals are provided to communications interface 58 via the communications link (i.e., channel) 60. This channel 60 carries signals and may be implemented using wire or cable, fiber optics, a phone line, a cellular phone link, an RF link, and/or other communications channels.

Of course, wireless access points 24 and 28, base stations 20 and master nodes 34 may have more than one set of communication interface 58 and communication link 60. For example, dual mode wireless access points 28 may have a communication interface 58/communication link 60 pair to establish communication zone 26 for GiLink wireless communication with mobile device 16, a second communication interface 58/communication link 60 pair for low speed, e.g., WLAN, wireless communication with mobile device 15, another communication interface 58/communication link 60 pair for communication with low speed wireless network 14 (via link 30) and still another communication interface 58/communication link 60 pair for communication with a master node 34 (via link 32).

In this document, the terms “computer program medium,” “computer usable medium,” and “computer readable medium” are used to generally refer to media such as main memory 40 and secondary memory 46, removable storage drive 50, a hard disk installed in hard disk drive 48, and signals. These computer program products are means for providing software to the wireless access points 24 and 28, base stations 20 and master nodes 34. The computer readable medium allows the computer system to read data, instructions, messages or message packets, and other computer readable information from the computer readable medium. The computer readable medium, for example, may include non-volatile memory, such as floppy, ROM, flash memory, disk drive memory, CD-ROM, and other permanent storage. It is useful, for example, for transporting information, such as data and computer instructions, between other devices within system 10. Furthermore, the computer readable medium may comprise computer readable information in a transitory state medium such as a network link and/or a network interface, including a wired network or a wireless network that allows a computer to read such computer readable information.

Computer programs (also called computer control logic) are stored in main memory 40 and/or secondary memory 46. Computer programs may also be received via communications interface 58. Such computer programs, when executed, enable the wireless access points 24 and 28, base stations 20 and master nodes 34 to perform the features of the present invention as discussed herein. In particular, the computer programs, when executed, enable the processor 36 to perform the features of the corresponding wireless access point 24 or 28, base station 20 and master node 34. Accordingly, such computer programs represent controllers of the corresponding device.

The present invention advantageously provides a system and method that can use unlicensed RF spectrum in the millimeter wave (“mmW”) such as the 60 GHz, Tera Hertz region. Such an arrangement allows short range, very high speed connectivity within an office or building, or other geographically restricted environment while also facilitating wide area networking using a wireless communication network and backbone whose maximum communication speed is less than that of the short range high speed connectivity network, e.g., the GiLink wireless network 12. In accordance with the present invention, peer-to-peer communication can be provided using GiLink wireless network 12, even where the end devices in the communication session do not enjoy line of sight placement. For example, mobile device 16 can communicate with wireless access point 24a while another mobile device can access GiLink wireless network 12 via wireless access point 24b. By routing communication from wireless access point 24a to wireless access point 24b via master nodes 34a and 34b, a peer-to-peer communication session can be established. As discussed above in detail, control plane session data, such as the location of the mobile devices can be provided by low speed wireless network 14 (not shown in FIG. 4).

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product that comprises all the features enabling the implementation of the methods described herein, and which, when loaded in a computing system is able to carry out these methods. Storage medium refers to any volatile or non-volatile computer readable storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A system for wireless communication with a mobile device, the system comprising:
a first wireless communication network having a first maximum wireless speed, the first communication network having a plurality of access points for communication with the mobile device;
a second wireless communication network having a second maximum wireless speed, the second wireless maximum speed being less than the first maximum wireless speed, the second wireless communication network being used to assist determination of connectivity for the mobile device on the first wireless communication network; and
at least one of the plurality of access points on the first wireless communication network being activated to engage in wireless communication with the mobile device based on the determined connectivity for the mobile device.

2. The system according to claim 1, determining connectivity includes determining a location of the mobile device and wherein activating an access point includes directing an antenna toward the wireless communication device based on the determined location of the mobile device.

3. The system according to claim 1, wherein the first wireless communication network is a gigabit link (“GiLink”) wireless communication network.

4. The system according to claim 1, wherein the first wireless communication network is in electronic communication with the second wireless communication network, the second wireless communication network transmitting data to the first wireless communication network, the transmitted data including location information of the mobile device.

5. The system according to claim 1, wherein at least one of the plurality of access points is arranged to communicate on both the first wireless communication network and the second wireless communication network, wherein the at least one access point receives the location information from the wireless device using the second wireless communication network.

6. The system according to claim 1, wherein the second wireless communication network is a cellular communication network, wherein the cellular communication network includes a plurality of base stations for communicating wirelessly with the mobile device at up to the second maximum speed.

7. The system according to claim 1, wherein the second wireless communication network is a WiFi network.

8. The system according to claim 1, wherein the first wireless communication network includes a first wireless backbone network, the first wireless backbone network having at least one master node in communication with the plurality of access nodes, wherein the second communication is further used to provide control information to allow the first communication network to establish a peer-to-peer communication session between the mobile device and another mobile device using the first wireless backbone network.

9. A method for wireless communication with a mobile device using a first wireless communication network having a first maximum wireless speed and having a plurality of access points for communication with the mobile device, and a second wireless communication network having a second maximum wireless speed in which the second wireless maximum speed is less than the first maximum wireless speed, the method comprising:
using the second wireless communication network to determine a location of the mobile device; and
activating at least one of the plurality of access points on the first wireless communication network to engage in wireless communication with the mobile device based on the determined location of the mobile device.

10. The method according to claim 9, wherein activating an access point includes directing an antenna toward the wireless communication device based on the determined location of the mobile device.

11. The method according to claim 9, wherein the first wireless communication network is a gigabit link (“GiLink”) wireless communication network.

12. The method according to claim 9, wherein the first wireless communication network is in electronic communication with the second wireless communication network, the method further comprising using the second wireless communication network to transmit data to the first wireless communication network, the transmitted data including location information of the mobile device.

13. The method according to claim 9, further comprising:
arranging at least one of the plurality of access points to communicate on both the first wireless communication network and the second wireless communication network, wherein the at least one access point receives the location information from the wireless device using the second wireless communication network.

14. The method according to claim 9, wherein the second wireless communication network is a cellular communication network, wherein the cellular communication network includes a plurality of base stations for communicating wirelessly with the mobile device at up to the second maximum speed.

15. The method according to claim 9, wherein the second wireless communication network is a WiFi network.

16. The method according to claim 9, wherein the first wireless communication network includes a first wireless backbone network, the first wireless backbone network having at least one master node in communication with the plurality of access nodes, wherein the method further comprises:
using the second communication to provide control information to allow the first communication network to establish a peer-to-peer communication session between the mobile device and another mobile device using the first wireless backbone network.

17. A system for wireless communication with a mobile device, the system comprising:
a first wireless communication network having a first maximum wireless speed;
a second wireless communication network having a second maximum wireless speed, the second wireless maximum speed being less than the first maximum wireless speed, the second wireless communication network providing control plane services for wireless communication between the mobile device and the first wireless communication network.

18. The system according to claim 17, wherein the control plane services include:
determining a location of the mobile device; and
providing the location of the mobile device to the first wireless communication network.

19. The system according to claim 17, wherein the first wireless communication network has a plurality of access points for communication with the mobile device, the control plane services including supporting wireless communication session handoff between two of the plurality access points.

20. The system according to claim 17, wherein the first wireless communication network includes a first wireless backbone network, the first wireless backbone network having at least one master node in communication with the plurality of access nodes, wherein the control plane services provides control information to allow the first communication network to establish a peer-to-peer communication session between the mobile device and another mobile device using the first wireless backbone network.
